(19) United States
(12) Patent Application Publication
(10) Pub. No.: US 2006/0260902 A1
(43) Pub. Date: Nov. 23, 2006

(54) Drive coupling mechanism and image forming apparatus therewith

(75) Inventors: Takeshi Marumoto, Osaka (JP); Tetsuro Kawashima, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/434,267

(22) Filed: May 16, 2006

(30) Foreign Application Priority Data
Nov. 9, 2005 (JP) 2005-324458
May 17, 2005 (JP) 2005-143866

(51) Int. Cl. F16D 13/00

(52) U.S. Cl. 192/89.2

(57) ABSTRACT

Through a coupling member 30, a drive-feed shaft 41a is fitted and, at the other end of the drive-feed shaft 41a, a drive-transmission gear 40a is fixed. By a compression spring 44, the coupling member 30 is loaded with a force that tends to move it in the direction indicated by arrow D, and is in a first position where the coupling member 30 coupling member 30 couples the drive-feed shaft 41a with a rotated member. When an arm member 33 is pulled up in the direction indicated by arrow E, a first rib 30a rides on a second rib 34 along a slanted surface 34a, and the coupling member 30 moves in the direction indicated by arrow D′ against the force exerted by the compression spring 44, and is retracted into a second position where the coupling member 30 decouples the rotated member from the drive-feed shaft 41a.

This application is based on Japanese Patent Application No. 2005-143866 filed on May 17, 2005 and Japanese Patent Application No. 2005-324458 filed on Nov. 9, 2005, the contents of which are hereby incorporated by reference.

### BACKGROUND OF THE INVENTION

1. Field of the Invention

The present invention relates to a drive coupling mechanism for coupling a rotated member and a drive transmission member together, and also to an image forming apparatus incorporating it.

2. Description of Related Art

In image forming apparatuses such as copiers, printers, and facsimile machines, various rotated members are used to perform image formation. For example, in an electrophotographic image forming section, a photoconductor drum is arranged and, in contact with the surface thereof, rotated members are arranged such as a transfer roller and a cleaning roller. The photoconductor drum and the rotated members are driven to rotate at fixed speeds while image formation is performed through processes of charging, exposure, formation of a toner image, transfer of the toner image to paper, cleaning of the drum surface, etc.

The construction of a conventional electrophotographic image forming apparatus is shown in FIG. 8. In FIG. 8, reference numeral 100 represents the image forming apparatus. Here, taken up as an example is a rotary-development color copier in which toner images of different colors are transferred to an intermediary transfer belt one after another to form a color image and then the color image is transferred all at once to paper.

In the image forming apparatus 100, a copying operation is performed in the following manner. In an image forming section 1 provided inside the body of the apparatus, an electrostatic latent image is formed based on an original document image read by an image input section 2. Toner is then attached to the electrostatic latent image by a developing unit 13 to form a toner image. The developing unit 13 receives the toner from a toner container 3. In this image forming apparatus 100, while a photoconductor drum 10 is rotated counter-clockwise (in the direction indicated by arrow A) as seen in FIG. 8, image forming processes are performed with respect to the photoconductor drum 10. The image forming processes performed in the image forming section 1 will be described later.

Reference numeral 16 represents an intermediary transfer belt to which the toner image is transferred. By being driven by unillustrated driving means, the intermediary transfer belt 16 rotates in the direction indicated by arrow B while keeping contact with the photoconductor drum 10. The intermediary transfer belt 16 is formed of a sheet of a dielectric resin, and is built as an endless belt produced by joining together both ends of the sheet with an overlap or as a seamless belt with no seam at all.

When image formation is started at a user's request, an yellow toner image is formed on the photoconductor drum 10 with predetermined timing. Then, at a predetermined transfer voltage, an electric field is applied to the intermediary transfer belt 16, and then a primary transfer roller 14 transfers the yellow toner image on the photoconductor drum 10 to the intermediary transfer belt 16. Thereafter the toner remaining on the surface of the photoconductor drum 10 is removed by cleaning means (unillustrated), and then the developing unit 13 rotates a predetermined angle so that, in a manner similar to that described above, a magenta toner image is formed on the photoconductor drum 10 and is then transferred to the intermediary transfer belt 16.

Thereafter, in a manner similar to that described above, a cyan toner image and then a black toner image are transferred from the photoconductor drum 10 to the intermediary transfer belt 16. These four-color images are formed in predetermined positions relative to one another so as to form a predetermined full-color image. Reference numeral 18 represents a secondary transfer roller provided below the intermediary transfer belt 16.

Toward the intermediary transfer belt 16 having the toner image formed as described above, paper P is conveyed from a paper feed mechanism 4 via paper feed rollers 5, a paper conveying passage 6a, and a pair of resist rollers 7, so that the toner image formed on the surface of the intermediary transfer belt 16 is transferred to the paper P by the secondary transfer roller 18. The paper P having the toner image transferred thereto is then conveyed to a fixing section 8 having a pair of fixing rollers 8a, so that the toner image is fixed. Having passed through the fixing section 8, the paper is directed, by a branching section 9, in one of a plurality of ways branched from one another. In a case where an image is formed only on one side of the paper, the paper is readily ejected to a paper ejecting section 30.

By contrast, In a case where images are formed on both sides of the paper, the paper P having passed through the fixing section 8 is then directed by the branching section 9 to a paper conveying passage 6b. The paper conveying direction is then switched back by feed rollers 32 provided within a switchback device 31, so that the paper is now directed, with the image side up, to a paper conveying passage 6c. The paper then passes via a reversing guide 33 and is then conveyed, with the image side down, again to the secondary transfer roller 18. Now the next image formed on the intermediary transfer belt 16 is transferred by the secondary transfer roller 18 to the side of the paper P on which no image has yet been formed. The paper is then conveyed to the fixing section 8, so that the toner image is fixed. Then the paper is ejected out of the apparatus via the paper ejecting section 30.

The paper feed mechanism 4 includes: paper feed cassettes 4a, 4b, and 4c that are detachably attached to the image forming apparatus 100 and that accommodate sheets of paper P; and a stack bypass (hand-feed tray) 4d that is provided above the paper feed cassettes 4a, 4b, and 4c. The paper feed cassettes 4a, 4b, and 4c and the stack bypass 4d all lead, via the paper conveying passage 6a, to the image forming section 1, which includes the photoconductor drum 10, the developing unit 13, the intermediary transfer belt 16, etc.

FIG. 9 is an enlarged view of a part of FIG. 8 around the image forming section 1. The image forming section 1 has a charging device 11, an exposing device 12, a developing unit 13, and a cleaning device 15 positioned on the circumferential surface of the photoconductor drum 10. Moreover, below the photoconductor drum 10, the intermediary transfer belt 16 and the primary transfer roller 14 are arranged in contact therewith.

The photoconductor drum 10 has, laid on the surface of a base cylindrical member, a photoconductive layer of amorphous silicon or the like several tens of micrometers thick, and is driven to rotate at a fixed speed in the direction indicated by arrow A (counter-clockwise). The charging device 11 causes corona charge whereby the surface of the photoconductor drum is charged to a potential of about several hundred volts. The exposing device (LED unit) 12 shines a light beam (for example, a laser beam) on the photoconductor drum 10 to form an electrostatic latent image thereon.

The developing unit 13 is a rotary type developing unit that feeds toner onto the photoconductor drum 10 by the use of a developing roller 13a arranged so as to face the photoconductor drum 10 with a small gap left in between. The developing unit 13 is provided with developing cartridges for different colors, namely, cyan, magenta, yellow, and black, each developing cartridge having a developing device and a toner case integrated together. These developing cartridges are rotated so that they are placed in a position facing the photoconductor drum 10 one after the next. In this way, toner of one color after another is attached to the electrostatic latent image on the photoconductor drum 10 to form toner images of the different colors. Here, only one of the developing cartridges is illustrated.

The cleaning device 15 has a cleaning roller 20, a cleaning blade 21, and a collecting spiral 22 housed in a housing molded of resin. The cleaning roller 20 has a roller portion formed around a core. The roller portion is formed of urethane foam or rubber, and is arranged in a position in which it makes contact with the surface of the photoconductor drum 10. While keeping contact with the photoconductor drum 10, the roller portion rotates and thereby shaves the surface of the drum to remove substances that are produced by charging and settle on the drum surface. The roller portion also serves to remove toner that, without being transferred to paper, remains on the surface of the photoconductor drum 10.

When image formation is started at a user's request, on the photoconductor drum 10 evenly charged by the charging device 11, an electrostatic latent image is recorded by the exposing device 12. The electrostatic latent image is then, through reversal development, made visible as a toner image, which is then transferred to the intermediary transfer belt 16 by the primary transfer roller 14.

The part of the toner left untransferred by the primary transfer roller 14 is, as residual toner, removed from the surface of the photoconductor drum 10 by the cleaning device 15 provided with the cleaning roller 20 and the cleaning blade 21. The residual toner thus removed is conveyed by a toner collecting device, such as the collecting spiral 22, to an unillustrated disposal bottle. Through the procedure described above, a yellow, a magenta, a cyan, and a black toner image are transferred to the intermediary transfer belt 16 one after another by the photoconductor drum 10. Reference numeral 19 represents a gear for driving the cam mechanism (unillustrated) for bringing and taking the intermediary transfer belt 16 and the secondary transfer roller 18 into and out of contact with each other.

In the image forming section constructed as described above, each unit is driven to rotate by a drive source such as a motor via a drive transmission system built with gears and the like. To drive rotation here, the drive force is generally transmitted via a high-precision gear or coupling formed around a flange portion press-fitted at an end of a unit. In particular, in cases where the transmission of a drive force needs to be cut on the occasion of replacement or maintenance of a unit, a coupling mechanism is provided somewhere between the driving means provided in the body of the apparatus and the part of the unit where it receives the drive force. This permits the drive force to be transmitted and cut as the coupling mechanism is coupled and decoupled.

Inconveniently, with a unit that cannot be mounted into position by being inserted along the rotation axis thereof, in particular with a unit that can only be mounted into position by being inserted from a direction perpendicular to the rotation axis thereof, the coupling receives a force acting in the direction in which the unit is mounted into or dismounted out of position. This may cause breakage of the coupling. To avoid this, the coupling needs to be equipped with a retraction mechanism for the occasion of assembly of the apparatus and replacement of the unit.

One method of retracting a coupling along the rotation axis is disclosed in JP-A-2003-280489. This publication discloses an image forming apparatus provided with a drive transmission cutting mechanism in which a coupling member fixed to a coupling shaft is retracted by pushing back the coupling shaft by the use of a helical cam or translation cam.

According to the method disclosed in JP-A-2003-280489 mentioned above, however, two helical cams or translation cams are needed, one at the front and another at the back in the axial direction, and in addition an extra space is needed into which to retract the coupling shaft itself. Disadvantageously, this makes the driven unit unduly thick in the axial direction, and hence make the apparatus unduly large. Moreover, a number of dedicated components are needed other than a driving gear train. Disadvantageously, this increases cost.

### SUMMARY OF THE INVENTION

In view of the conventionally experienced inconveniences mentioned above, it is an object of the present invention to provide a drive coupling mechanism that permits a driven unit to be mounted and dismounted with a simple construction and with no increase in arrangement space or in the number of components, and to provide an image forming apparatus incorporating such a drive coupling mechanism.

To achieve the above object, according to the present invention, a drive coupling mechanism is provided with: a coupling member that is slidably fitted outside a drive-feed shaft so as to rotate therewith and thereby transmit a drive force to a rotated member; loading means for loading the coupling member with a force that tends to move the coupling member toward a first position in which the coupling member is coupled with a coupling provided on the rotated member; and coupling switching means for placing the coupling member selectively in one of the first position and a second position in which the coupling member is decoupled from the rotated member and is retracted toward the drive-feed shaft.

With this structure, only the coupling member is retracted along the drive-feed shaft, and there is no need for a space into which to retract the drive-feed shaft. This helps make slimmer and more compact than ever the coupling mechanism that permits the rotated member to be mounted and dismounted in a direction perpendicular to the drive-feed shaft.

According to the present invention, preferably, in the drive coupling mechanism described above, the coupling switching means is composed of: a coupling pressing member that is rotatably fitted outside the drive-feed shaft so as to slide with the coupling member; and an arm member that is arranged so as to face the coupling pressing member from the direction of the rotated member. Here, as the arm member slides, the coupling pressing member rides on a slanted surface provided on the arm member and thereby permits the coupling member to be retracted into the second position against the force exerted by the loading means.

With this structure, the coupling mechanism can achieve coupling and decoupling with a simple structure by the use of the coupling pressing member that slides with the coupling member along the drive-feed shaft and the arm member that has the slanted surface formed thereon to permit the coupling pressing member to ride thereon.

According to the present invention, preferably, in the drive coupling mechanism described above, on the arm member, a locking portion is formed that locks the coupling pressing member.

With this structure, the locking portion formed on the arm member holds the coupling member in the second position even when the arm member is not held in a use's hand. This makes the maintenance and replacement of the rotated member easy.

According to the present invention, preferably, in the drive coupling mechanism described above, a first rib that is brim-shaped is provided on the outer circumferential surface of the coupling member, and the coupling switching means is composed of: an arm member that encloses the side surface of the coupling member from both sides and that is arranged so as to face the first rib from the direction of the rotated member; and a slide bracket that has a guide hole in which the coupling member is loosely fitted to prevent displacement of the axial center of the coupling member and that holds the arm member so that the arm member is slidable in a direction perpendicular to the drive-feed shaft. Moreover, a second rib that has a slanted surface is provided in a part of the arm member facing the first rib, and as the arm member slides, the first rib rides on the second rib along the slanted surface and thereby permits the coupling member to be retracted into the second position against the force exerted by the loading means.

With this structure, the coupling mechanism can achieve coupling and decoupling with a simple structure, and in addition the reduced number of components helps achieve cost reduction in the apparatus. Moreover, the slide bracket helps achieve smooth sliding of the arm member, and helps prevent displacement of the axial center of the coupling mechanism at the time of taking apart and pressing together.

According to the present invention, preferably, on the top surface of the second rib, a locking portion is formed that locks the first rib.

With this structure, the locking portion formed on the top surface of the second rib holds the coupling member in the second position even when the arm member is not held in a use's hand. This makes the maintenance and replacement of the rotated member easy.

According to the present invention, preferably, the slanted surface has a slope of 45 degrees or less.

With this structure, the arm member can be slid with a weaker force. This helps enhance the operability of the arm member.

According to the present invention, an image forming apparatus is provided with the drive coupling mechanism structured as described above.

With this structure, it is possible to realize an image forming apparatus that permits easy maintenance and replacement of a rotated member and that is compact and low-cost.

According to the present invention, in the image forming apparatus as described above, after the coupling switching means has placed the coupling member in the second position, the coupling switching means then, in response to the mounting of another unit, places the coupling member in the first position.

With this structure, after maintenance or replacement work is done with the coupling member moved into the second position, a user or service person never happens to forget to place the coupling switching means back into the original position.

### BRIEF DESCRIPTION OF THE DRAWINGS

FIG. 1 is a perspective view showing the coupling members and the coupling switching means used in the drive coupling mechanism of a first embodiment of the present invention;

FIG. 2 is a perspective view of the coupling members and the coupling switching means, as seen from the reverse side of the plane of FIG. 1;

FIG. 3 is a front view of the drive coupling mechanism in its assembled state, as seen from the direction of the slide brackets;

FIG. 4 is a side cross-sectional view of the drive coupling mechanism of the first embodiment;

FIG. 5 is a plan cross-sectional view of the drive coupling mechanism of the first embodiment;

FIG. 6 is a perspective view of the drive coupling mechanism of a second embodiment of the present invention, in its assembled state, as seen from the direction of the coupling members;

FIG. 7 is a side view of the drive coupling mechanism of the second embodiment;

FIG. 8 is a schematic cross-sectional view showing the overall construction of a conventional image forming apparatus; and

FIG. 9 is a cross-sectional view showing the construction of a principal part of the image forming section of the conventional image forming apparatus.

### DETAILED DESCRIPTION OF PREFERRED EMBODIMENTS

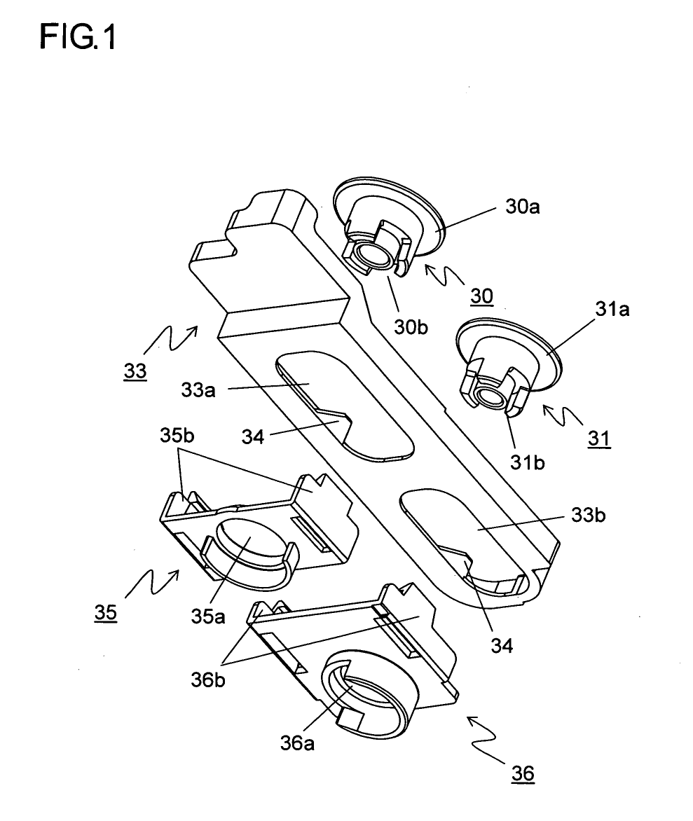

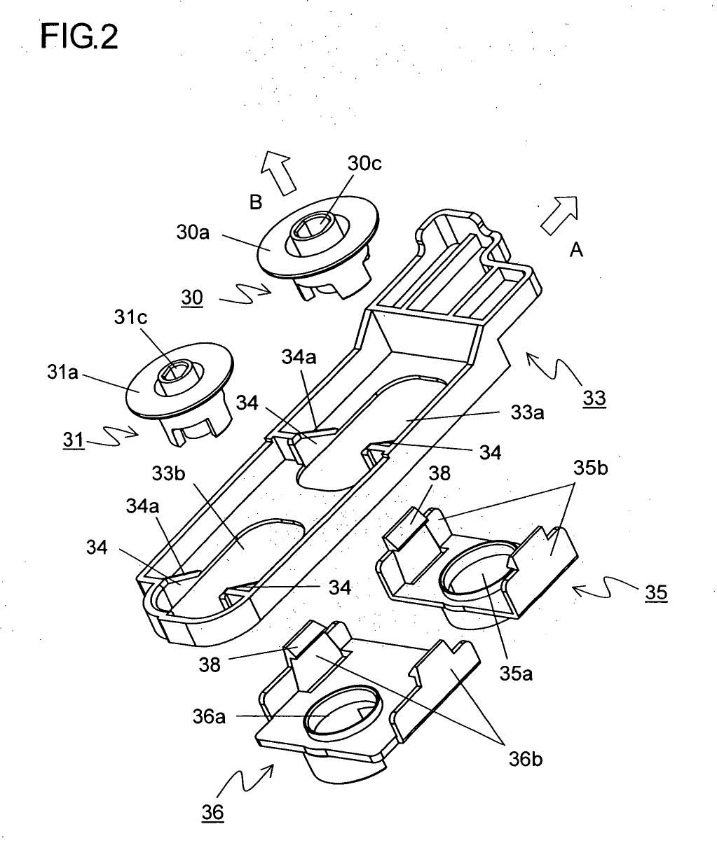

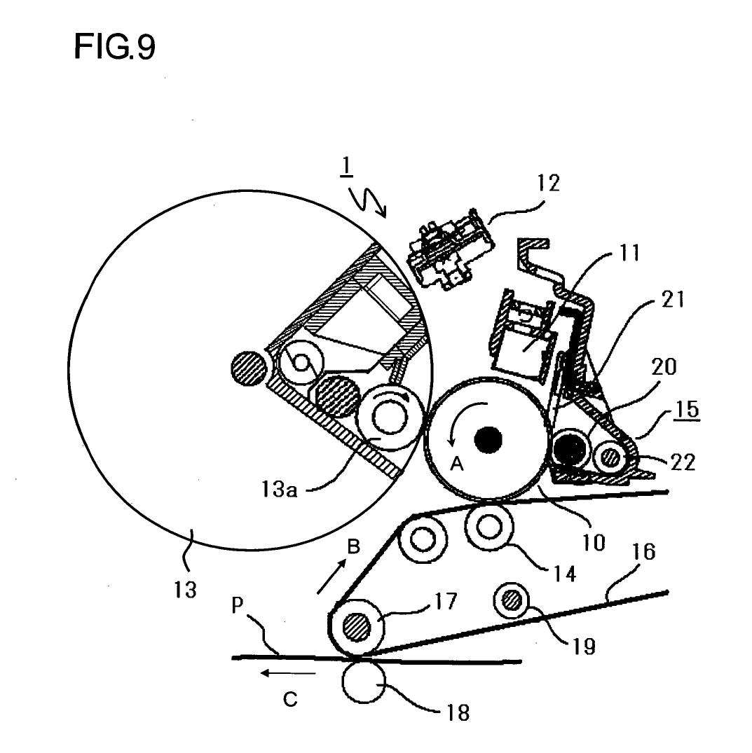

Hereinafter, embodiments of the present invention will be described with reference to the drawings. FIG. 1 is a perspective view showing the coupling members and the coupling switching means used in the drive coupling mechanism of a first embodiment of the present invention, and FIG. 2 is a perspective view thereof, as seen from the reverse side of the plane of FIG. 1. What is shown here is a drive coupling mechanism that couples a photoconductor drum 10 and a drive roller 17 (for both, see FIG. 9) to a drive-feed shaft. It is assumed that the a coupling member 30 is coupled to the photoconductor drum 10, and that a coupling member 31 is coupled to the drive roller 17.

On the coupling members 30 and 31, respectively, brim-shaped first ribs 30a and 31a are provided that project from the outer circumferential surfaces of the cylindrical body portions thereof and, at the tip ends of the body portions, engagement portions 30b and 31b are formed that engage with the couplings provided on rotated members. Moreover, through axial center portions of the coupling members 30 and 31, respectively, center holes 30c and 31c are formed that are ovally shaped so as to fit the cross-sectional shapes of drive-feed shafts (unillustrated).

Reference numeral 33 represents an arm member that moves the coupling members 30 and 31 along the drive-feed shafts to thereby permit the coupling mechanism to achieve coupling and decoupling. Reference numerals 35 and 36 represent slide brackets that, with guide ribs 35b and 36b thereof, slidably hold the arm member 33. At the tip ends of the guide ribs 35b and 36b, respectively, locking claws 38 are provided to permit the arm member 33 to slide without coming off the guide ribs 35b and 36. The coupling member 30 is put through a slide hole 33a in the arm member 33 and through a guide hole 35a in the slide bracket 35, and is coupled to the rotary shaft of the photoconductor drum 10. The coupling member 31 is put through a slide hole 33b in the arm member 33 and through a guide hole 36a in the slide bracket 36, and is coupled to the rotary shaft of the drive roller 17. As a result of the coupling members 30 and 31 being loosely fitted in the guide holes 35a and 36a, the coupling mechanism is prevented from displacement of the axial center thereof at the time of taking apart and pressing together.

The slide holes 33a and 33b and the guide holes 35a and 36a are formed larger than the outer diameters of the coupling members 30 and 31 so that, when the coupling mechanism is assembled, their rims do not interfere with the coupling members 30 and 31 and thereby displace the axial centers of the drive-feed shafts. The slide holes 33a and 33b are formed with widths smaller than the diameters of the first ribs 30a and 31a. The arm member 33 encloses the side surfaces of the coupling members 30 and 31 from both sides, and is arranged so as to face the first ribs 30a and 31a from the direction of the rotated member.

On the arm member 33, at both sides of the slide holes 33a and 33b, respectively, second ribs 34 are provided that faces the first ribs 30a and 31a on the coupling members 30 and 31. In portions of the second ribs 34 where they make contact with the first ribs 30a and 31a when the arm member 33 slides, slanted surfaces 34a are formed. Thus, as the arm member 33 is slid in the direction indicated by arrow A in FIG. 2, the first ribs 30a and 31a ride on the second ribs 34 along the slanted surfaces 34a, so that the first ribs 30a and 31a move a distance equal to the height of the second ribs 34 along the drive-feed shafts (in the direction indicated by arrow B).

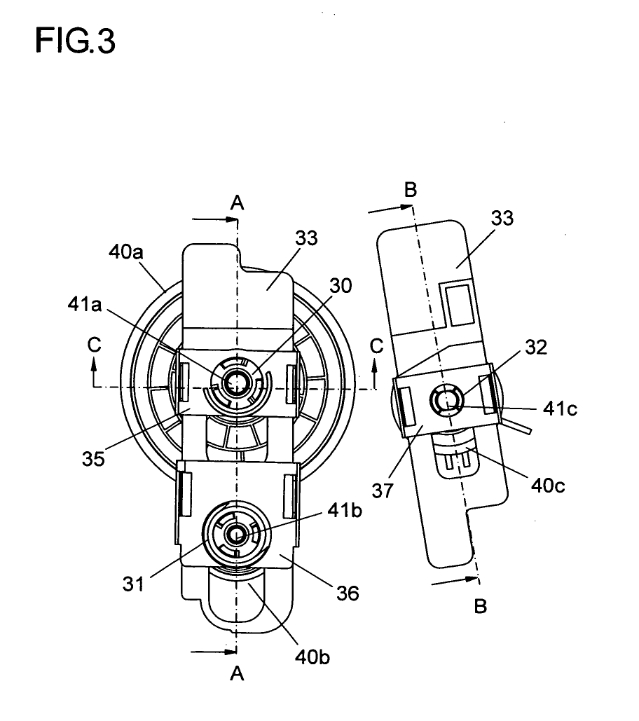

FIG. 3 is a front view of the drive coupling mechanism in its assembled state, as seen from the direction of the slide brackets. Such parts as are found also in FIGS. 1 and 2 are identified with common reference numerals, and no description thereof will be repeated. In FIG. 3, at the left is shown the drive coupling mechanism that couples the photoconductor drum 10 and the drive roller 17 (for both, see FIG. 9) with the drive-feed shafts, and at the right is shown the drive coupling mechanism that couples a gear 19 (see FIG. 9) to a drive-feed shaft. The drive coupling mechanism at the right includes a coupling member 32, an arm member 33, and a slide bracket 37 structured in a manner similar to that shown in FIGS. 1 and 2.

Through the coupling members 30 to 32, the drive-feed shafts 41a to 41c are put and, at the other ends of the drive-feed shafts 41a to 41c, drive-transmission gears 40a to 40c are fixed. The slide brackets 35 to 37 are fixed to an unillustrated drive side plate, and the arm member 33 is slidable along the slide brackets 35 to 37 in a direction perpendicular to the drive-feed shafts 41a to 41c (in the up/down direction in FIG. 3).

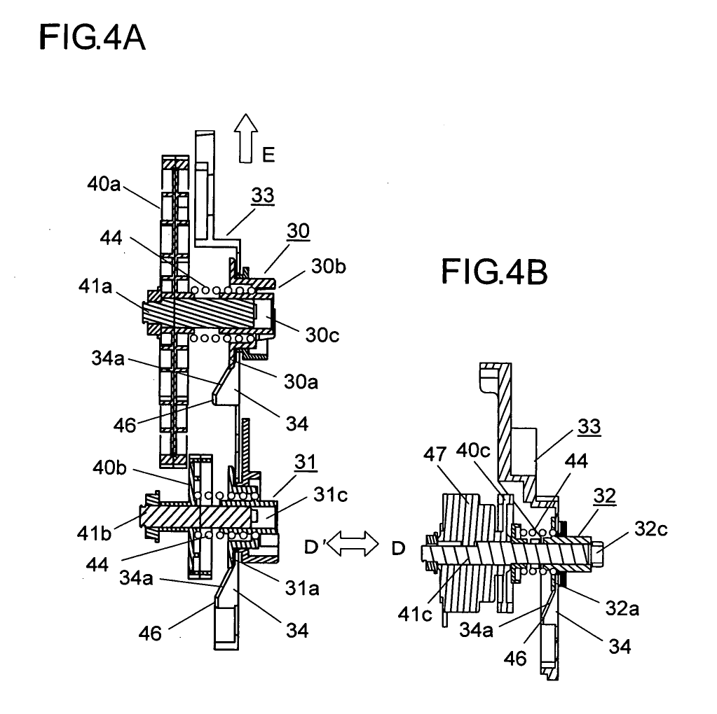

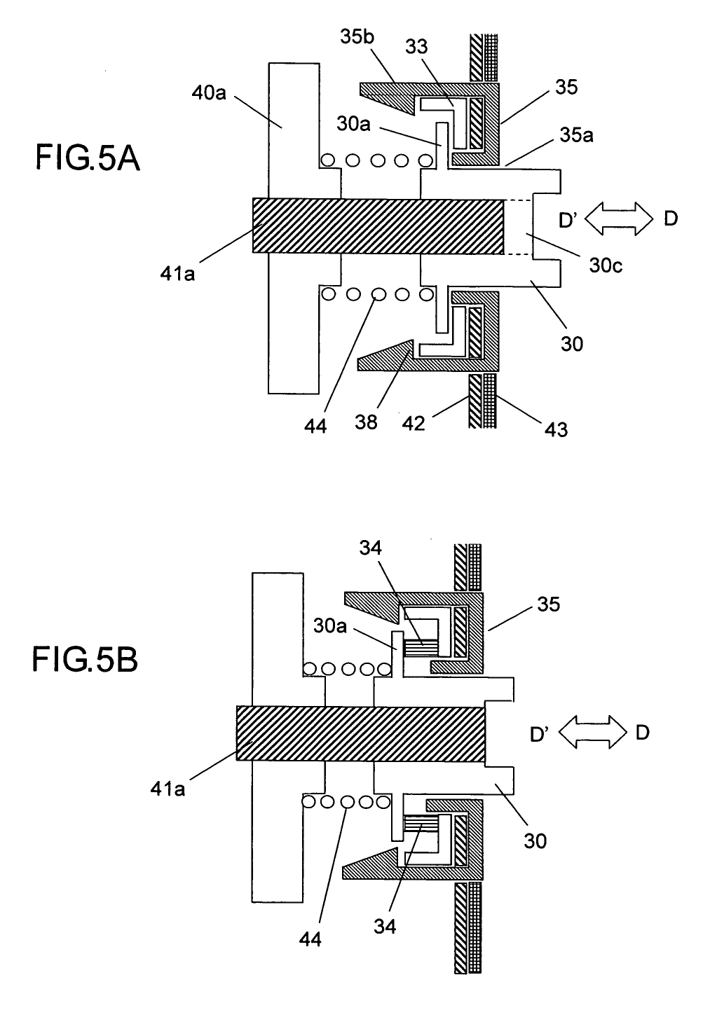

FIGS. 4A and 4B are side cross-sectional vies of the drive coupling mechanism (taken along lines A-A and B-B shown in FIG. 3), and FIGS. 5A and 5B are plan cross-sectional views of the drive coupling mechanism (along line C-C shown in FIG. 3). The structure shown in FIG. 4B is the same as that shown in FIG. 4A except that a clutch mechanism 47 is additionally provided that transmits or cuts the rotation of the gear 19 (see FIG. 9).

The drive-feed shafts 41a to 41c are chamfered to fit the shapes of the center holes 30c to 32c (here, ovally shaped), so that the coupling members 30 to 32 rotate with the drive-feed shafts 41a to 41c and are slidable in the axial direction (in the direction indicated by arrow DD′). Between the coupling members 30 to 32 and drive-transmission gears 40a to 40c, compression springs 44 are sandwiched, so that the drive-feed shafts 41a to 41c are put through the compression springs 44.

FIGS. 4A, 4B, and 5A show the sate in which the coupling members 30 to 32 are loaded by the compression springs 44 with forces that tend to move them in the direction indicated by arrow D and are thus located in a position (hereinafter referred to as the first position) where they are coupled with rotated members (unillustrated). Now the coupling and decoupling operation of the coupling mechanism according to the present invention will be described, taking up as a representative the coupling member 30 that is coupled with the photoconductor drum 10 (see FIG. 9).

As shown in FIG. 5A, the coupling member 30 is put through the guide hole 35a in the slide bracket 35 fixed to a drive side plate 42, and protrudes from a left side plate 43 toward the photoconductor drum 10. By the force exerted by the compression spring 44 (acting in the direction indicated by arrow D) and the reactional force from the photoconductor drum 10 (acting in the direction indicated by arrow D′), the coupling member 30 is rotatably held without making contact with the arm member 33 and the slide bracket 35. This permits the drive force from the drive-feed shaft 41a to be smoothly transmitted to the photoconductor drum 10.

In this state, when the arm member 33 is pulled up in the direction indicated by arrow E shown in FIG. 4A, the first rib 30a rides on the second rib 34 along the slanted surface 34a. Thus, as shown in FIG. 5B, the coupling member 30 moves in the direction indicated by arrow D′ against the force exerted by the compression spring 44, and is retracted along the drive-feed shaft 41a into a position (hereinafter referred to as the second position) where the 30 is decoupled from the photoconductor drum 10.

Moreover, as shown in FIGS. 4A and 4B, at the upper end of the slanted surface 34a, that is, on the top surface of the second rib 34, a flat locking portion 46 is formed so that, when the arm member 33 is fully pulled up, the first rib 30a is locked on the locking portion 46. Thus, even when the arm member 33 is not held in a user's hand, the coupling member 30 is held in the second position. This permits smooth maintenance and replacement of the photoconductor drum 10.

After the photoconductor drum 10 is mounted, when the arm member 33 is pushed down, the first rib 30a is unlocked from the locking portion 46 and falls onto the slanted surface 34a, and thus the coupling member 30 moves back to the first position. Depending on the positions, relative to each other, of the engagement portion 30b of the coupling member 30 and the coupling provided on the photoconductor drum 10, the coupling mechanism may not fit readily. Even then, starting to drive the coupling member 30 to let it rotate a predetermined angle permits the engagement portion 30b to reach the position where it fits on the coupling provided on the photoconductor drum 10, so that, by the force exerted by the compression spring 44, the coupling mechanism automatically fits.

The height of the second rib 34 is set adequately to suite the distance over which the coupling member 30 is retracted. The slope of the slanted surface 34a is subject to no particular restriction. If the slope is too sharp, however, pulling up the arm member 33 requires an unduly strong force, leading to poor operability. For this reason, it is preferable that the slanted surface 34a have a slope of 45° or less. The description of the coupling and decoupling operation of the coupling mechanism thus far given with respect to the coupling member 30 applies quite equally to the coupling members 31 and 32.

With the structure described above, where only the coupling members 30 to 32 are retracted along the drive-feed shafts 41a to 41c, it is possible to eliminate the need for an extra space for the retraction of the drive-feed shafts 41a to 41c, and thereby to make the coupling mechanism slimmer than ever. Moreover, since the additionally needed dedicated components are the arm member 33 and the slide brackets 35 to 37 only, it is possible to avoid increased complexity and higher cost in assembly work resulting from an increased number of components.

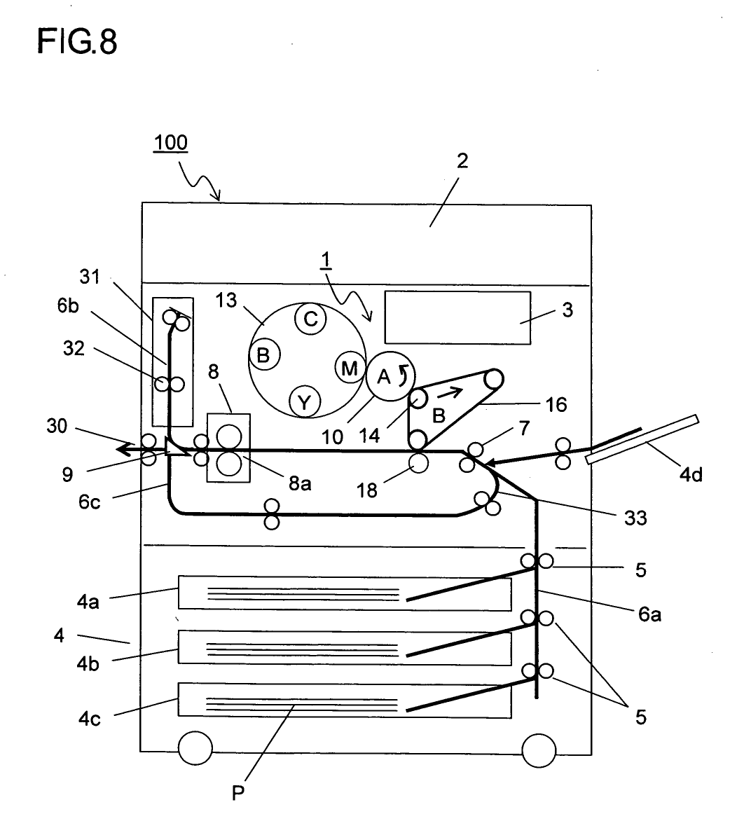

Moreover, with the structure described above, on completion of the maintenance or replacement of a rotated member, the arm member 33 needs to be pushed down to move the coupling members 30 to 32 back to the first position. If a user or service person forgets to push down the arm member 33, the drive force is not transmitted to the rotated member, and thus image formation does not start. To avoid this, a structure may be adopted in which the arm member 33 is pushed down when a unit such as the toner container 3 (see FIG. 8) is mounted on top thereof. This prevents a user or service person from forgetting to return the arm member 33.

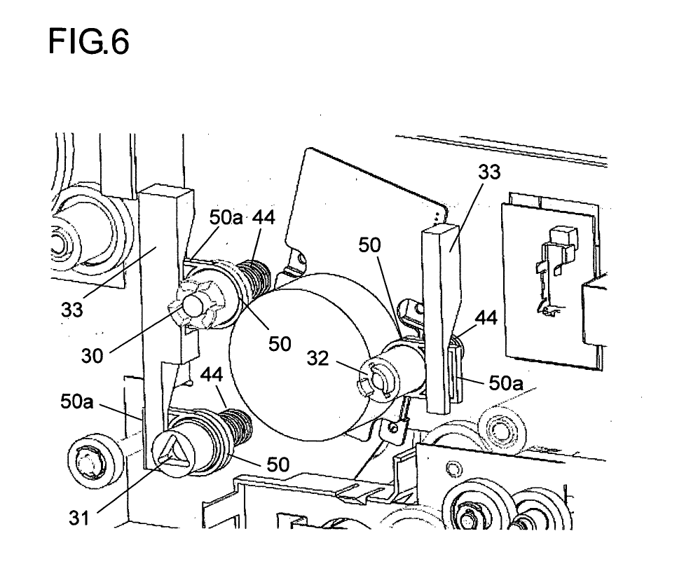

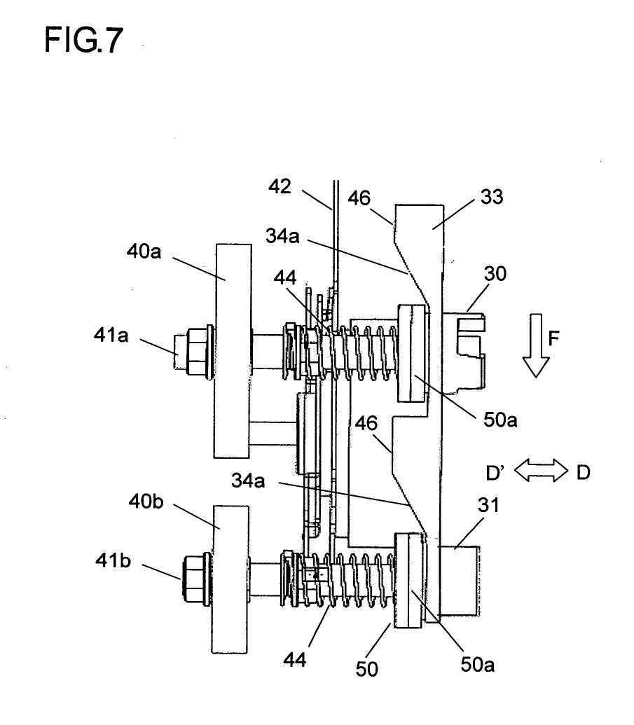

FIG. 6 is a perspective view of the drive coupling mechanism of a second embodiment of the present invention, as seen from the direction of the coupling members, and FIG. 7 is a left side view of FIG. 6. Such parts as are found also in FIGS. 1 to 5 showing the first embodiment are identified with common reference numerals, and no description thereof will be repeated. In this embodiment, the coupling members 30 to 32 have no first ribs 30a to 32a; instead, coupling pressing members 50 that slide with the coupling members 30 to 32 in the thrust direction are rotatably fitted outside the drive-feed shafts 41a to 41c.

Parts of the outer circumferences of the coupling pressing members 50 are formed into projections 50a, and slanted surfaces 34a formed on the arm members 33 are arranged to face those projections 50a. In this embodiment, no slide brackets 35 and 36 (see FIG. 1) are provided; the arm member 33 is supported, so as to be slidable in the up/down direction, between an unillustrated drive side plate, having through holes formed therein to permit the coupling members 30 to 32 to protrude therethrough, and the coupling pressing members 50. FIG. 7 shows the state in which the coupling members 30 and 31 are loaded by the compression springs 44 with forces that tend to move them in the direction indicated by arrow D and are in the first position where they are coupled to rotated members (unillustrated).

In the state shown in FIG. 7, when the arm member 33 is pushed down in the direction indicated by arrow F, the projections 50a ride on the slanted surfaces 34a, and the coupling members 30 and 31 move in the direction indicated by arrow D′ against the forces exerted by the compression springs 44. Thus, the coupling members 30 and 31 are retracted along the drive-feed shafts 41a and 41b into the second position where they are decoupled from the photoconductor drum 10 and the drive roller 17 (for both, see FIG. 9).

When the arm member 33 is fully pushed down, the projections 50a are locked on the locking portions 46 on the arm member. After the photoconductor drum 10 is mounted, when the arm member 33 is pulled up, the projections 50a are unlocked from the locking portions 46 and fall onto the slanted surfaces 34a, and thus the coupling members 30 and 31 move back to the first position.

Thus, as in the first embodiment, it is possible to eliminate the need for an extra space for the retraction of the drive-feed shafts 41a and 41b, and thereby to make the coupling mechanism slimmer. It is also possible to avoid increased complexity and higher cost in assembly work resulting from an increased number of components.

As in the first embodiment, the slope of the slanted surface 34a and the height of the locking portion 46 may be set adequately. From the viewpoint of operability, it is preferable that the slope of the slanted surface 34a be 45° or less. The description of the coupling and decoupling operation of the coupling mechanism thus far given with respect to the coupling members 30 and 31 applies quite equally to the coupling member 32.

It should be understood that maybe modifications and variations are possible within the scope and spirit of the present invention. For example, although the embodiments described above deal with cases where the drive coupling mechanism according to the present invention is applied to the coupling between three rotated members, namely the photoconductor drum 10, the drive roller 17, and the gear 19, and their respective drive-feed shafts, it may be applied to only one or two of these, or may be applied further to the coupling of another rotated member.

In the second embodiment, the arm member 33 is pushed down to move the coupling members 30 to 32 into the second position. Alternatively, the direction of the slope of the slanted surface 34a may be reversed so that, when the arm member 33 is pulled up, the coupling members 30 to 32 are moved into the second position. As in the first embodiment, a structure may be adopted in which the arm member 33 is pushed down when a unit is mounted on top of the arm member 33. This prevents a user or service person from forgetting to return the arm member 33. Instead of using compression springs to load the coupling members with forces that tend to hold them in the first position, any other type of springs may be used such as tension springs, torsion springs, or plate springs.

As an example of an image forming apparatus incorporating the drive coupling mechanism according to the present invention, a color copier of an intermediate transfer type has been discussed. It should however be understood that the present invention is equally applicable to coupling mechanisms used in copiers such as digital multifunction products, tandem-type color copiers, analog monochrome copiers, and other various image forming apparatuses such as facsimile machines and laser printers.

According to the present invention, only a coupling member is retracted along a drive-feed shaft. This eliminates the need for a space for retracting the drive-feed shaft, and thus helps realize, with a structure slimmer and simpler than ever, a coupling mechanism that can achieve coupling and decoupling between a rotated member and the drive-feed shaft.

Moreover, a coupling switching means is built with an arm member having a slanted surface and a coupling pressing member. This permits the coupling mechanism to achieve coupling and decoupling with a structure simpler than ever. Furthermore, forming a rib, which rides on the slated surface, integrally with the coupling member helps reduce the number of components and the number of assembly steps.

Moreover, the arm member has a locking portion formed thereon. Thus, even when the arm member is not held in a use's hand, it can be held in the slid state, and the coupling members can be held in a second position. This permits easier maintenance and replacement of the rotated member. Giving the slanted surface a slope of 45° or less permits the arm member to be slid with a moderate force, leading to enhanced operability of the arm member.

Moreover, by the use of the drive coupling mechanism according to the present invention, it is possible to realize, at a low cost, an image forming apparatus that permits easy maintenance and replacement of a rotated member. Moreover, since the drive unit can be made slim, the image forming apparatus can be made compact. By adopting a structure in which the arm member is pushed down into its original position at the same time that another unit is mounted, it is possible to prevent a user or service person, having done maintenance or replacement work with the coupling mechanism decoupled, from forgetting to return the arm member.

What is claimed is:

1. A drive coupling mechanism comprising:
a coupling member that is slidably fitted outside a drive-feed shaft so as to rotate therewith and thereby transmit a drive force to a rotated member;
loading means for loading the coupling member with a force that tends to move the coupling member toward a first position in which the coupling member is coupled with a coupling provided on the rotated member; and
coupling switching means for placing the coupling member selectively in one of the first position and a second position in which the coupling member is decoupled from the rotated member and is retracted toward the drive-feed shaft.

2. The drive coupling mechanism of claim 1, wherein
the coupling switching means is composed of:
a coupling pressing member that is rotatably fitted outside the drive-feed shaft so as to slide with the coupling member; and
an arm member that is arranged so as to face the coupling pressing member from a direction of the rotated member, and
as the arm member slides, the coupling pressing member rides on a slanted surface provided on the arm member and thereby permits the coupling member to be retracted into the second position against a force exerted by the loading means.

3. The drive coupling mechanism of claim 2, wherein
on the arm member, a locking portion is formed that locks the coupling pressing member in the second position.

4. The drive coupling mechanism of claim 1, wherein
a first rib that is brim-shaped is provided on an outer circumferential surface of the coupling member,
the coupling switching means is composed of:
an arm member that encloses a side surface of the coupling member from both sides and that is arranged so as to face the first rib from a direction of the rotated member; and
a slide bracket that has a guide hole in which the coupling member is loosely fitted to prevent displacement of an axial center of the coupling member and that holds the arm member so that the arm member is slidable in a direction perpendicular to the drive-feed shaft,
a second rib that has a slanted surface is provided in a part of the arm member facing the first rib, and
as the arm member slides, the first rib rides on the second rib along the slanted surface and thereby permits the coupling member to be retracted into the second position against a force exerted by the loading means.

5. The drive coupling mechanism of claim 4, wherein
on a top surface of the second rib, a locking portion is formed that locks the first rib.

6. The drive coupling mechanism of claim 2, wherein
wherein the slanted surface has a slope of 45 degrees or less.

7. The drive coupling mechanism of claim 3, wherein
wherein the slanted surface has a slope of 45 degrees or less.

8. The drive coupling mechanism of claim 4, wherein
wherein the slanted surface has a slope of 45 degrees or less.

9. The drive coupling mechanism of claim 5, wherein
wherein the slanted surface has a slope of 45 degrees or less.

10. An image forming apparatus comprising the drive coupling mechanism of claim 1.

11. An image forming apparatus comprising the drive coupling mechanism of claim 2.

12. An image forming apparatus comprising the drive coupling mechanism of claim 3.

13. An image forming apparatus comprising the drive coupling mechanism of claim 4.

14. An image forming apparatus comprising the drive coupling mechanism of claim 5.

15. The image forming apparatus of claim 10, wherein
after the coupling switching means has placed the coupling member in the second position, the coupling switching means then, in response to mounting of another unit, places the coupling member in the first position.

16. The image forming apparatus of claim 11, wherein
after the coupling switching means has placed the coupling member in the second position, the coupling switching means then, in response to mounting of another unit, places the coupling member in the first position.

17. The image forming apparatus of claim 12, wherein
after the coupling switching means has placed the coupling member in the second position, the coupling switching means then, in response to mounting of another unit, places the coupling member in the first position.

18. The image forming apparatus of claim 13, wherein
after the coupling switching means has placed the coupling member in the second position, the coupling switching means then, in response to mounting of another unit, places the coupling member in the first position.

19. The image forming apparatus of claim 14, wherein
after the coupling switching means has placed the coupling member in the second position, the coupling switching means then, in response to mounting of another unit, places the coupling member in the first position.
